(19) United States
(12) Patent Application Publication
(10) Pub. No.: US 2012/0216179 A1
(43) Pub. Date: Aug. 23, 2012

(54) METHODS AND APPARATUS TO MANAGE INSTANCES OF AN ENTERPRISE CLINICAL INFORMATION SYSTEM

(75) Inventors: Niranjan Kumar Sharma, Salt Lake City, UT (US); Douglas Adamson, Salt Lake City, UT (US)

(73) Assignee: GENERAL ELECTRIC COMPANY, A NEW YORK CORRPORATION, Schenectady, NY (US)

(21) Appl. No.: 13/031,389

(22) Filed: Feb. 21, 2011

(51) Int. Cl. G06F 9/44

(52) U.S. Cl. 717/168

(57) ABSTRACT

Methods and apparatus to manage instances of an enterprise clinical information system are disclosed. An example apparatus includes an instance tracker to obtain information related to a first instance of a clinical information system associated with a first healthcare entity of the clinical information system, wherein a plurality of instances of the clinical information system are installed in association with a plurality of healthcare entities of the clinical information system; an extractor to extract information related to a first application of the first instance of the clinical information system associated with the first entity and to extract information related to a second application of a second instance of the clinical information system associated with a second entity of the clinical information system; a dependency calculator to calculate dependency data of the first and second applications, wherein the dependency data indicates whether the first application is dependent on the second application; and an updater to, when the dependency data indicates that the second application is dependent on the first application, update the second application in response to an update to the first application.

### FIELD OF THE DISCLOSURE

The present disclosure relates generally to healthcare information systems and, more particularly, to methods and apparatus to manage instances of an enterprise clinical information system.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. Operation of such healthcare information systems can vary from one healthcare entity to another.

### SUMMARY

An example apparatus includes an instance tracker to obtain information related to a first instance of a clinical information system associated with a first healthcare entity of the clinical information system, wherein a plurality of instances of the clinical information system are installed in association with a plurality of healthcare entities of the clinical information system; an extractor to extract information related to a first application of the first instance of the clinical information system associated with the first entity and to extract information related to a second application of a second instance of the clinical information system associated with a second entity of the clinical information system; a dependency calculator to calculate dependency data of the first and second applications, wherein the dependency data indicates whether the first application is dependent on the second application; and an updater to, when the dependency data indicates that the second application is dependent on the first application, update the second application in response to an update to the first application.

An example computer implemented method includes obtaining information related to a first instance of a clinical information system associated with a first healthcare entity of the clinical information system, wherein a plurality of instances of the clinical information system are installed in association with a plurality of healthcare entities of the clinical information system; extracting information related to a first application of the first instance of the clinical information system associated with the first entity and to extract information related to a second application of a second instance of the clinical information system associated with a second entity of the clinical information system; calculating dependency data of the first and second applications, wherein the dependency data indicates whether the first application is dependent on the second application; and when the dependency data indicates that the second application is dependent on the first application, updating the second application in response to an update to the first application.

An example tangible machine readable medium has instructions stored thereon that, when executed, cause a machine to at least obtain information related to a first instance of a clinical information system associated with a first healthcare entity of the clinical information system, wherein a plurality of instances of the clinical information system are installed in association with a plurality of healthcare entities of the clinical information system; extract information related to a first application of the first instance of the clinical information system associated with the first entity and to extract information related to a second application of a second instance of the clinical information system associated with a second entity of the clinical information system; calculate dependency data of the first and second applications, wherein the dependency data indicates whether the first application is dependent on the second application; and when the dependency data indicates that the second application is dependent on the first application, update the second application in response to an update to the first application.

### BRIEF DESCRIPTION OF THE DRAWINGS

FIG. 1 is a block diagram of an example healthcare information environment.

FIG. 2 is a block diagram of an example apparatus that may be used to implement the example enterprise bundle store (EBS) system of FIG. 1.

FIG. 3 is a diagram illustrating an example configuration of the example EBS system of FIGS. 1 and/or 2.

FIG. 4 is a flow diagram representative of example machine readable instructions that may be executed to implement the example EBS system of FIGS. 1 and/or 2.

FIG. 5 is a block diagram of an example processor system that may be used to execute the machine readable instructions of FIG. 4 to implement the example EBS system of FIGS. 1 and/or 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Generally, the example methods, apparatus, systems, and/or articles of manufacture disclosed herein enable an enterprise clinical information system (ECIS) to manage instances of the ECIS running in association with each of the healthcare entities that utilize, are registered with, or otherwise are associated with the ECIS. Among other functions and/or benefits, the ECIS supports healthcare practitioners in decision making processes by aggregating healthcare information across disparate enterprises and/or entities thereof and referencing collection(s) of data (e.g., guidelines, recommendations related treatment and/or diagnosis, studies, histories, etc.) to automatically generate supportive information to be communicated to one or more healthcare practitioners related to the aggregated healthcare information. Additionally, the ECIS described herein enables different healthcare entities that utilize the ECIS to customize one or more aspects of information exchange and/or execution of applications to tailor to the preferences and/or needs of a specific healthcare entity. In such instances, different versions or instances of the ECIS are installed at the healthcare entit(ies) to implement the customizations created thereby. The examples disclosed herein enable the ECIS to track and manage the various instances of the ECIS of the various the healthcare entities. In some examples, tracking and managing the ECIS instances using the examples disclosed herein includes determining which applications of different instances of the ECIS of different healthcare entities may be dependent on other applications of the same or different instances of the ECIS. Moreover, the examples disclosed herein enable the ECIS to strategically update instances of the ECIS that depend on an application that has been modified by one of the healthcare entities. At the same time, the examples disclosed herein enable applications unaffected by modifications made to one or more of other applications to remain unchanged and, therefore, to continue operation without need for an update. In other words, the examples disclosed herein track dependencies among applications across the ECIS and ensure continued proper operation of the applications by updating the applications when necessary. In some examples, tracking and managing the ECIS instances using the example disclosed herein includes maintaining license information for one or more of the healthcare entities and for one or more of the applications utilized thereby. The examples disclosed herein enable the ECIS to ensure compliance with licensing agreements when updating the ECIS instances to reflect modifications made to interdependent application(s). Additional aspects, advantages and benefits of the example methods, apparatus, systems, and/or articles of manufacture disclosed herein are described in greater detail below in connection with the figures.

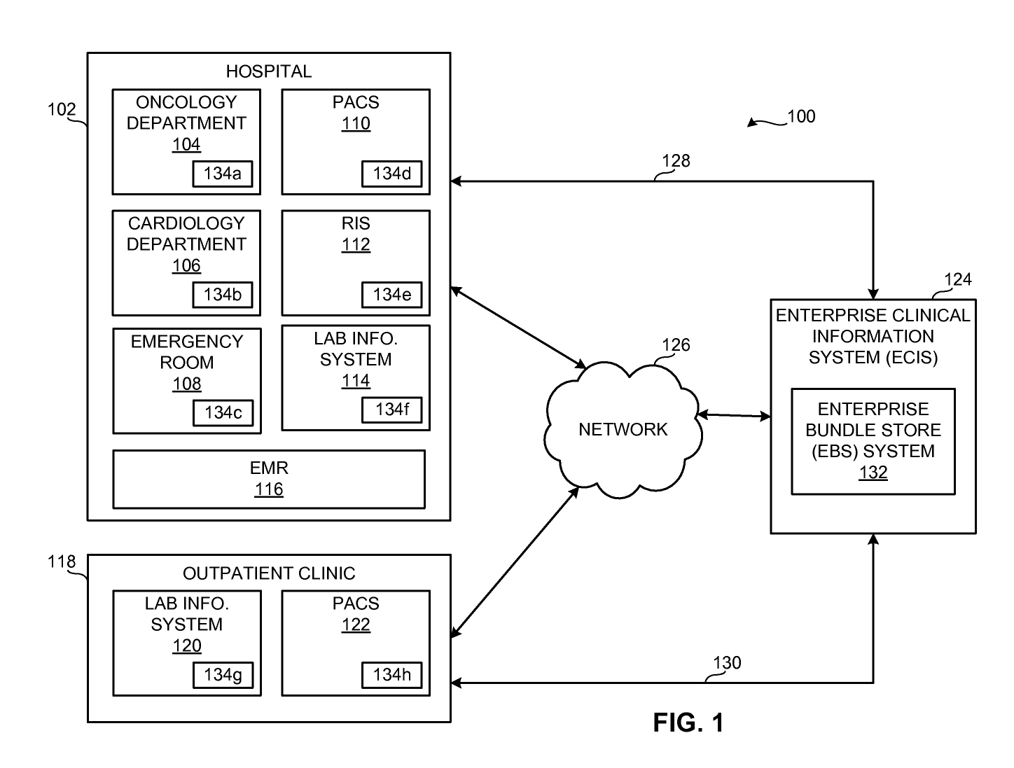

FIG. 1 is a block diagram of an example healthcare environment 100 in which the example methods, apparatus, systems, and/or articles of manufacture disclosed herein for tracking and managing instances of an ECIS system may be implemented. The example healthcare environment 100 of FIG. 1 includes a first hospital 102 having a plurality of entities operating within and/or in association with the first hospital 102. In the illustrated example, the entities of the first hospital 102 include an oncology department 104, a cardiology department 106, an emergency room system 108, a picture archiving and communication system (PACS) 110, a radiology information system (RIS) 112, and a laboratory information system (LIS) 114. The oncology department 104 includes cancer-related healthcare practitioners, staff and the devices or systems that support oncology practices and treatments. Similarly, the cardiology department 106 includes cardiology-related healthcare practitioners, staff and the devices and/or systems that support cardiology practices and treatments. Notably, the example oncology department 104 of FIG. 1 has customizations related to, for example, clinical workflows configured to be executed in response to certain events and/or according to a schedule, general processing of healthcare messages, patient handling policies or procedures, etc. specifically tailored for the oncology department 104. The customizations may be based on, for example, preferences of practitioners, capabilities, requirements or obligations, standards, protocols, etc. associated with the oncology department 104. At the same time, the example cardiology department 106 of FIG. 1 has similar, additional, or alternative customizations to similar, additional or alternative healthcare aspects as the oncology department 104. For example, the oncology department 104 may execute a first set of actions in response to receiving a Health Level 7 (HL7) Admit Discharge Transfer (ADT) message, while the cardiology department 106 may execute a second set of actions different from the first set of actions in response to receiving a HL7 ADT message. Such differences may also exist between the emergency room 108, the PACS 110, the RIS 112 and/or the accounting services 114.

Briefly, the emergency room system 108 manages information related to the emergency care of patients presenting at an emergency room of the hospital 102, such as admission information, observations from emergency examinations of patients, treatments provided in the emergency room setting, etc. The PACS 110 stores medical images (e.g., x-rays, scans, three-dimensional renderings, etc.) as, for example, digital images in a database or registry. Images are stored in the PACS 110 by healthcare practitioners (e.g., imaging technicians, physicians, radiologists) after a medical imaging of a patient and/or are automatically transmitted from medical imaging devices to the PACS 110 for storage. The RIS 112 stores data related to radiology practices such as, for example, radiology reports, messages, warnings, alerts, patient scheduling information, patient demographic data, patient tracking information, and/or physician and patient status monitors, as well as enables exam order entry (e.g., ordering an x-ray of a patient) and image and film tracking (e.g., tracking identities of one or more people that have checked out a film). The lab information system 114 stores clinical information such as lab results, test scheduling information, corresponding practitioner(s), and/or other information related to the operation(s) of one or more labs at the corresponding healthcare facility. While example types of information are described above as being stored in certain elements of the hospital 102, different types of healthcare data may be stored in one or more of the entities 104-114, as the entities 104-114 and the information listed above is included herein as non-limiting examples. Further, the information stored in entities 104-114 may overlap and/or be combined into one or more of the entities 104-114. Each of the example entities 104-114 of FIG. 1 interacts with an electronic medical record (EMR) system 116. Generally, the EMR 116 stores electronic copies of healthcare records associated with, for example, the hospital 102 and the entities 104-114 thereof.

The example healthcare environment 100 of FIG. 1 also includes an outpatient clinic 118 as an example of another healthcare enterprise. The example outpatient clinic 118 of FIG. 1 includes a lab information system 120 and a PACS 122 that operate similarly to the corresponding entities of the example hospital 102. The lab information system 120 and the PACS 122 of the example outpatient clinic 118 operate according to customized policies, procedures, workflows, etc. that differ between each other and the policies, procedures, workflows, etc. of the entities 104-114 of the hospital 102. Thus, differences in policies, procedures, workflows, etc. can exist between the entities of a healthcare enterprise and between healthcare enterprises in general.

In the illustrated example of FIG. 1, the hospital 102 and the outpatient clinic 118 are in communication with an ECIS 124 via a network 126, which may be implemented by, for example, a wireless or wired Wide Area Network (WAN) such as a private network or the Internet, an intranet, a virtual private network, a wired or wireless Local Area Network, etc. More generally, any of the coupling(s) described herein may be via a network. Additionally or alternatively, the example hospital 102 and/or the example outpatient clinic 118 are in communication with the example ECIS 124 via direct or dedicated transmission mediums 128 and 130.

Generally, the ECIS 124 supports healthcare information processing implemented by systems, devices, applications, etc. of healthcare enterprises, such as the hospital 102 and the outpatient clinic 118. The ECIS 124 is capable of processing healthcare messages from different entities of healthcare enterprises (e.g., the entities 104-114 of the hospital 102) that may generate, process and/or transmit the healthcare messages differently and/or using different formats, protocols, policies, terminology, etc. when generating, processing, and/or transmitting the healthcare messages. Moreover, the example ECIS 124 of FIG. 1 supports healthcare practitioners in decision making processes by aggregating healthcare information across disparate enterprises and/or entities thereof and referencing collection(s) of data to automatically generate suggestive and/or definitive data for communication to one or more healthcare practitioners related to the aggregated healthcare information.

To enable the example ECIS 124 of FIG. 1 to manage instances of the ECIS installed at each healthcare entity that utilizes the ECIS 124, the example ECIS 124 of FIG. 1 includes an enterprise bundle store (EBS) system 132. In the illustrated example of FIG. 1 a plurality of instances 134 of the ECIS 124 are associated with components (e.g., servers) of the healthcare entities 104-114, 120 and 122. As described in greater detail below, each of the ECIS instances 134 corresponds to a state of a runtime environment associated with the ECIS 124 at a particular point in time. In the illustrated example, the ECIS 124 enables a hot deployment of new versions and/or modifications of applications on the part of the entities 104-114, 120 and 122. That is, the entities 104-114, 120 and 122 that utilize the ECIS 124 are capable of generating, implementing, and deploying customized applications, or bundles including the applications, dynamically at runtime. The runtime environment is refreshed or modified when a new version of, for example, an application is installed on servers of one of the entities 104-114, 120 and/or 122. As a result of such refreshing on the runtime environment, new instances of the ECIS 124 are integrated with (e.g., installed on or tied to) the components (e.g., servers) of at least one (e.g., the entity having a new or modified application that caused the refresh of the runtime environment) of the entities 104-114, 120 and 122.

Additionally, the example ECIS 124 of FIG. 1 enables interactions between the applications and/or application bundles associated with different entities and/or applications and/or application bundles within the same entity. For example, a first application bundle associated with the oncology department 104 may call (e.g., utilize a function or class object of) a second application bundle associated with the laboratory information system 114 of the hospital 102 or the laboratory information system 120 of the outpatient clinic 118. As a result, the first application bundle is dependent on the second application in that a change in the second application bundle may affect the ability of the first application to operate properly or as intended.

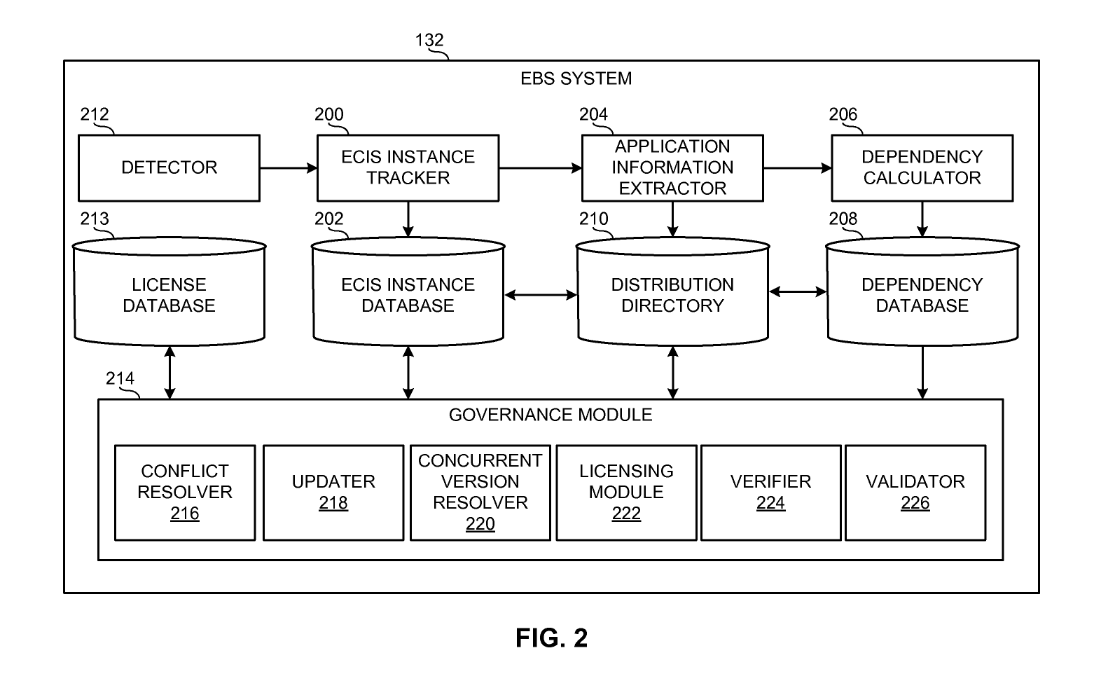

Generally, the example EBS system 132 of FIG. 1 uses data related to the different instances 134 of the ECIS 124 installed at the entities 104-114, 120 and 122 to maintain the instances 134 and the proper interactions between the applications thereof. For example, the example EBS system 132 calculates and/or obtains dependency information indicative of how the applications spread across the entities 104-114, 120 and 122 depend on one another. In some examples, the EBS system 132 uses the calculated and/or obtained dependency information to govern the instances 134 of the ECIS 124 running in association with the entities 104-114, 120 and 122 by, for example, updating one or more of the instances 134 in response to a new application (or application bundle) and/or a modification to an existing application (or application bundle), resolving conflict issues between interdependent applications, tracking licensing information related to authorizations for one or more of the entities 104-114, 120 and 122 to utilize one or more applications, and/or determining whether concurrent versions of the same application can be installed and maintained for one or more of the entities 104-114, 120 and 122. Additional or alternative functions, aspects and advantages of the example EBS system 132 disclosed herein are described below in connection with FIGS. 2-4 below.

FIG. 2 is a block diagram of an example apparatus that may be used to implement the example EBS system 132 of FIG. 1. In the illustrated example of FIG. 2, the example EBS system 132 includes an ECIS instance tracker 200, an ECIS instance database 202, a application information extractor 204, a dependency calculator 206, a dependency database 208, a distribution directory 210, a detector 212, a license database 213, and a governance module 214 including a conflict resolver 216, an updater 218, a concurrent version resolver 220, a licensing module 222, a verifier 224, and a validator 226. While an example manner of implementing the EBS system 132 of FIG. 1 has been illustrated in FIG. 2, one or more of the elements, processes and/or devices illustrated in FIG. 2 may be combined, divided, re-arranged, omitted, eliminated and/or implemented in any other way. Further, the example ECIS instance tracker 200, the example application information extractor 204, the example dependency calculator 206, the example distribution directory 210, the example detector 212, the example governance module 214, the example conflict resolver 216, the example updater 218, the example concurrent version resolver 220, the example verifier 222, the example validator 224, and/or, more generally, the example EBS system 132 of FIG. 2 may be implemented by hardware, software, firmware and/or any combination of hardware, software and/or firmware. Thus, for example, any of the example ECIS instance tracker 200, the example application information extractor 204, the example dependency calculator 206, the example distribution directory 210, the example detector 212, the example governance module 214, the example conflict resolver 216, the example updater 218, the example concurrent version resolver 220, the example verifier 222, the example validator 224, and/or, more generally, the example EBS system 132 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example ECIS instance tracker 200, the example application information extractor 204, the example dependency calculator 206, the example distribution directory 210, the example detector 212, the example governance module 214, the example conflict resolver 216, the example updater 218, the example concurrent version resolver 220, the example verifier 222, the example validator 224, and/or, more generally, the example EBS system 132 of FIG. 2 are hereby expressly defined to include a tangible medium such as a memory, DVD, CD, etc., storing the software and/or firmware. Further still, the example EBS system 132 of FIG. 2 may include one or more elements, processes and/or devices in addition to, or instead of, those illustrated in FIG. 2, and/or may include more than one of any or all of the illustrated elements, processes and devices.

The example ECIS instance tracker 200 of FIG. 2 communicates with each of the entities 104-114, 120 and 122 of FIG. 1 to identify, request and/or receive data related to the respective ones of the ECIS instances 134 associated with the entities 104-114, 120 and 122. The information received and/or obtained by the example ECIS instance tracker 200 includes, for example, version identifiers assigned to current ECIS application instances 134, version identifiers assigned to the application bundles of the current ECIS application instances 134, copies of the application bundles of the current ECIS application instance 134, dates and/or times of installation of the current ECIS application instances 134, and/or any other suitable type of information associated with the ECIS instances 134. The information retrieved and/or obtained via the example ECIS instance tracker 200 is stored in the ECIS instance database 202.

Further, the example ECIS instance tracker 200 conveys at least some of the instance data to the example application information extractor 204. In the illustrated example, the applications generated, implemented and/or otherwise utilized by the entities 104-114, 120 and 122 are integrated into the ECIS 124 via application bundles that can be dynamically deployed at runtime. Thus, the applications to be tracked and/or managed by the example EBS system 132 are sometimes presented to the example EBS system 132 in application bundles. The example application information extractor 204 of FIG. 2 extracts data related to the application bundles and/or the applications themselves from the data received from the example ECIS instance tracker 200. As a result of the extraction, the example application information extractor 204 has information indicative of the application(s) in each bundle that corresponds to one of the ECIS instances 134. In other words, the example application information extractor 204 gathers data showing what applications and what versions of the applications are associated with each of the ECIS instances 143.

As an illustration, healthcare practitioners associated with the oncology department 104 may desire a first clinical workflow to be executed in response to receiving an ADT message. In such an instance, a first customized ADT application is created and deployed in the ECIS 124 to meet the needs of the practitioners associated with the oncology department 104. The first ADT application is deployed in the ECIS 124 in a first application bundle along with additional applications. Similarly, healthcare practitioners associated with the cardiology department 106 may desire a second clinical workflow, different from the first clinical workflow, to be executed in response to receiving an ADT message. Therefore, a second customized ADT application is created and deployed in the ECIS 124 to meets the needs of the practitioners associated with the cardiology department 106. The second ADT application is deployed in the ECIS 124 in a second application bundle along with additional applications. As a result, two different entities 104 and 106 of the hospital 102 each have a version of an application in an application bundle that executes in response to ADT messages. Accordingly, a first ECIS instance 134a associated with the oncology department 104 differs from a second ECIS instance 134b associated with the cardiology department 106. This and additional information related to the application bundles associated with each of the instances 134 is stored in the example distribution directory 210. Further, the example detector 212 detects additions of applications to one or more of the ECIS instances 134 and/or modifications made to one or more existing applications. When such additions or modifications are detected by the example detector 212, the example ECIS instance tracker 200 obtains data related to the new or modified application. In such instances, the example detector 212 may convey identifying information associated with the new or modified application(s) to the example ECIS instance tracker 200 to facilitate the gathering of such data.

The example dependency calculator 206 identifies dependencies between the application bundles across the ECIS 124. To continue the above example, the ADT responsive application of the oncology department 104 may be dependent on the ADT responsive application of the cardiology department 106 and vice versa. In such instances, the operation of an application of the first ECIS instance 134a is dependent on the operation of the application of the second ECIS instance 134b and vice versa. That is, at least one application of the first and second instances 134a and 134b is interdependent. The example dependency calculator 206 identifies these dependencies and stores the dependencies in the dependency database 208. In the illustrated example, the dependency calculator 206 identifies dependencies among application by analyzing information (e.g., metadata or labeling data) received and/or obtained in association with the applications and/or by scanning code of the applications to determine whether the application calls on other applications. However, additional or alternative methods or techniques can be used to calculate dependencies between applications of the ECIS 124.

Generally, the example governance module 214 of FIG. 2 uses the information stored in the ECIS instance database 202, the distribution directory 210, and the dependency database 208 to maintain the instances 134 of the ECIS 124. In the illustrated example of FIG. 2, the components of the example governance module 214 provide instance management services to the ECIS 124. For example, the updater 218 of the example governance module 214 is responsive to a detection of a new or modified application by the detector 212. As described above, the example detector 212 also determines an identity of the new or modified application. The example updater 218 uses the identity of the new of modified application to query the dependency database 208. The dependency database 208 returns any dependencies related to the new of modified application. For example, a modified application associated with the ECIS instance 134b of the cardiology department 106 and an application associated with the ECIS instance 134f of the laboratory information system 114 may be interdependent. Accordingly, the example updater 218 would update the ECIS instance 134f with a new or modified ECIS instance or version including the functionality of the new or modified application.

In some examples, the updater 218 works in conjunction with the example licensing module 222 to confirm that an entity corresponding to the ECIS instance to be updated has any necessary licenses for such an update to be installed. For example, the updater 218 may convey an identity of the new or modified application and an identity of the ECIS instance to be updated to the licensing module 222. In response, the example licensing module 222 references the example license database 213, which stores current licensing agreements associated with each of the entities 104-114, 120 and 122. The example licensing module 222 can then determine whether the entity at issue currently has a license for the new or modified application and can convey an indication of that determination to the example updater 218. The example updater 218 can forego updating any ECIS instance 134 that lacks any necessary license(s) for an update. Additionally or alternatively, the example licensing module can detect and track any unlicensed use of application across the ECIS 124 and, in some example, communication an indication of such use to, for example, an administrator of the ECIS 124.

In some examples, the updater 218 works in conjunction with the example conflict resolver 216 to determine whether and/or how a conflict between instances 134 of the ECIS 124 is to be resolved. For example, the updater 218 may attempt to update an ECIS instance 134c of the emergency room 108 in response to a modification to an interdependent application in an instance 134f of the laboratory information system 114. The conflict resolver 216 may first determine whether such an update will cause a conflict with one or more aspects of either of the instances 134c and 134f. If so, the example conflict resolver 216 generates a report regarding the potential conflict and communicates the report to, for example an administrator of the ECIS 124. The administrator can then take corrective action according to one or more conflict policies or procedures. Additionally or alternatively, the example conflict resolver 216 may automatically implement conflict policies or procedures and may automatically determine which version of the ECIS 124 should be installed or maintained at the appropriate entit(ies) according thereto. In the illustrated example, the updater 218 performs the update(s) (if any) according to the decision of the conflict resolver 216.

In some examples, the updater 218 works in conjunction with the example concurrent version resolver 220 to determine whether multiple versions of the same application can be installed concurrently on one or more ECIS instances 134 to be updated. For example, an entity such as the oncology department 104 may desire to have multiple versions of a certain clinical data processing application for different circumstances to be handled in different manners. The example concurrent version resolver 220 receives such requests and determines whether such a configuration is workable. To do so, the example concurrent version resolver references the dependency database 208 to determine whether one or more dependencies make the multiple version configuration implausible and/or adversely affects one or more aspects of the ECIS 124. If so, the example concurrent version resolver 220 informs the updater 218 that the multiple versions can exist in the corresponding instances 134 concurrently and the example updater 218 implements such an update.

The example verifier 224 is capable of analyzing an application or an application bundle to determine whether the design and implementation (e.g., software) of the application or application bundle meets one or more sets of standards, limitations, specifications, protocols, etc. That is, the example verifier 224 verifies that certain engineering or design standards have been satisfied by the design of the applications of the instances 134. The example verifier 224 of FIG. 2 associates an indication of verification or non-verification with an entry of the respective application in, for example, the distribution directory 210, which stores the applications of the ECIS 124. The example validator 226 is capable of analyzing an application or an application bundle to determine whether the application or application bundle meets needs of the corresponding healthcare entity (e.g., a customer of a provider of the ECIS 124). That is, the example validator 226 validates the quality of the application and the ability of the application to meet a set of quality control standards. The example validator 226 of FIG. 2 associates an indication of validation or non-validation with an entry of the respective application in, for example, the distribution directory 210.

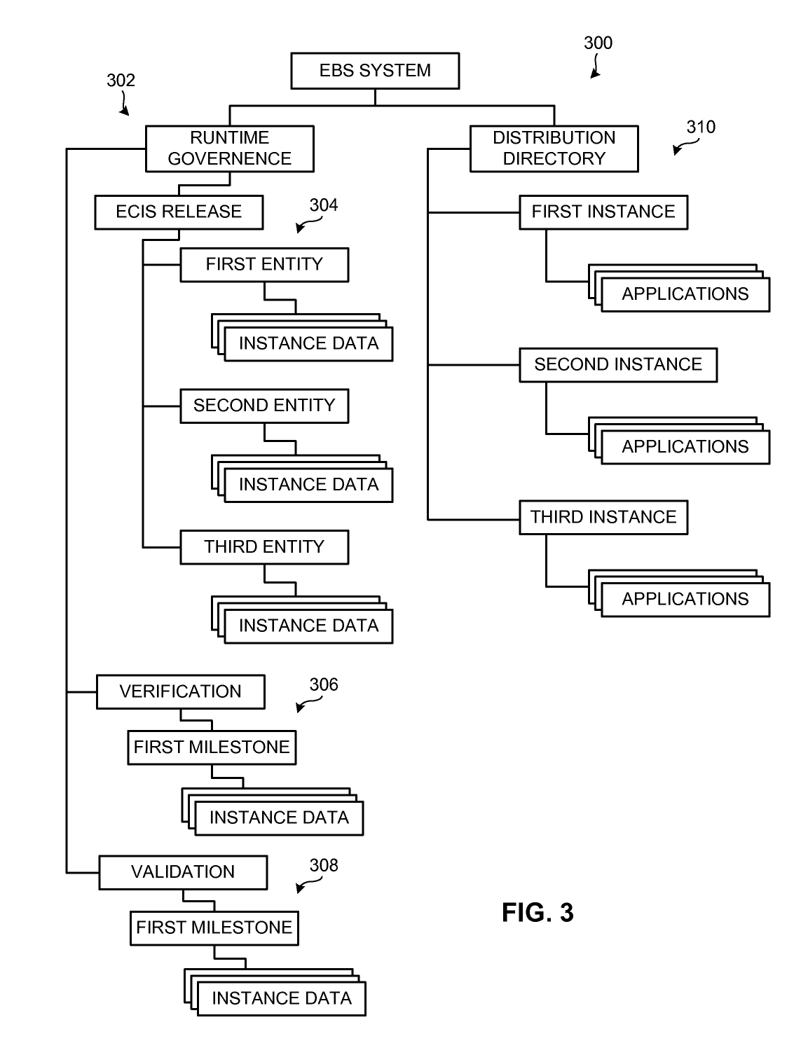

FIG. 3 is a diagram 300 illustrating an example configuration of the example EBS system of FIGS. 1 and/or 2. A first column 302 of the example diagram 300 corresponds to the example governance module 214 of FIG. 1. A first portion 304 of the first column 302 includes ECIS release information that is stored in the example ECIS instance database 202 as received and/or obtained by the example ECIS instance tracker 200. As shown in FIG. 3, entities of healthcare enterprises (e.g., the hospital 102, the outpatient clinic 118, etc.) have corresponding entries in the example ECIS instance database 202 and each of the entries includes instance data related to the instances 134 of the corresponding entity.

A second portion 306 of the first column 302 includes verification information that is generated by the example verifier 224 of FIG. 2. As described above, an indication of verification can be stored in association with entries of the distribution directory 210 and/or the ECIS instances database 202. A third portion 308 of the first column 302 includes validation information that is generated by the example validator 226 of FIG. 2. As described above, an indication of validation can be stored in association with entries of the distribution directory 210 and/or the ECIS instances database 202.

A second column 310 of the example diagram 300 of FIG. 3 corresponds to the example distribution directory 210 and the example dependency database 208 of FIG. 2. As shown in FIG. 3, the distribution directory 210 includes entries for the ECIS instances 134 of the entities 104-114, 120 and 122. For each of the instances 134, the applications thereof are and information associated therewith are stored in association with the instance entries. Additionally, the dependency information among the application (e.g., within the same instance and across different instances) is stored in the example dependence database 208.

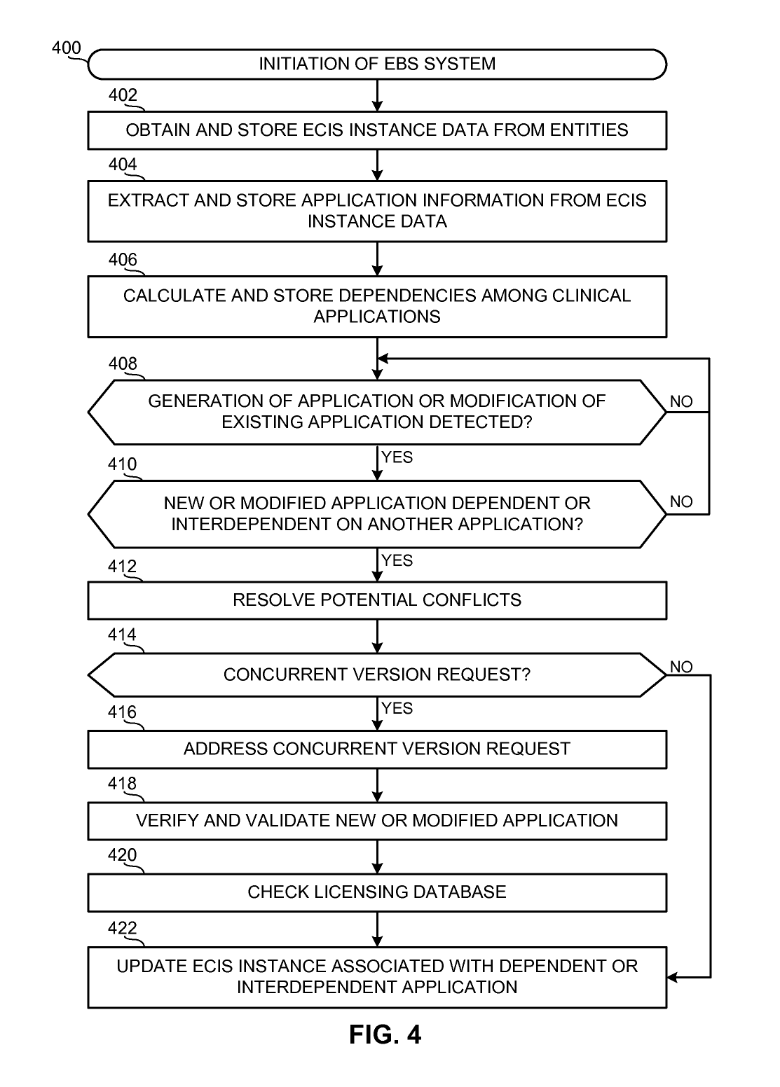

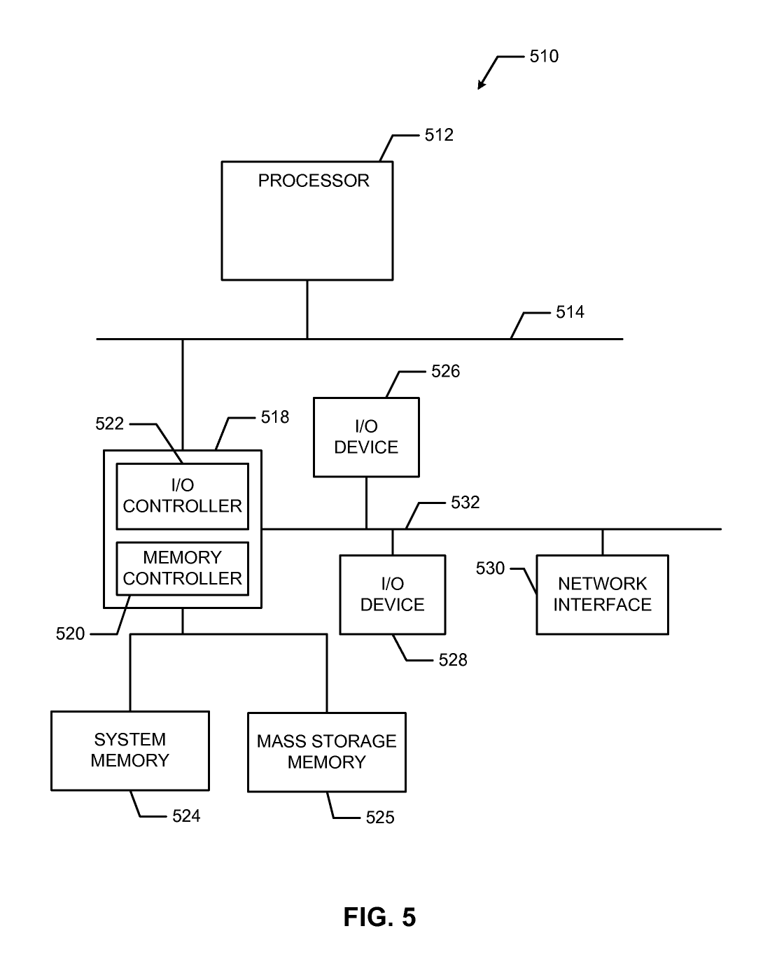

The flow diagram depicted in FIG. 4 is representative of machine readable instructions that can be executed to implement the example EBS system 132 of FIGS. 1 and/or 2 to track and manage instances of an ECIS. The example processes of FIG. 4 may be performed using a processor, a controller and/or any other suitable processing device. For example, the example processes of FIG. 4 may be implemented in coded instructions stored on a tangible medium such as a flash memory, a read-only memory (ROM) and/or random-access memory (RAM) associated with a processor (e.g., the example processor 512 discussed below in connection with FIG. 5). Alternatively, some or all of the example processes of FIG. 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 4 may be implemented manually or as any combination(s) of any of the foregoing techniques, for example, any combination of firmware, software, discrete logic and/or hardware. Further, although the example processes of FIG. 4 are described with reference to the flow diagrams of FIG. 4, other methods of implementing the processes of FIG. 4 may be employed. For example, the order of execution of the blocks may be changed, and/or some of the blocks described may be changed, eliminated, sub-divided, or combined. Additionally, any or all of the example processes of FIG. 4 may be performed sequentially and/or in parallel by, for example, separate processing threads, processors, devices, discrete logic, circuits, etc.

Turning to FIG. 4, an initiation occurs which may occur in response to any suitable triggering event, such as an installation of the ECIS 124 of FIG. 1 in a healthcare enterprise, such as the hospital 102 (block 400). Initially, the example ECIS instance tracker 200 obtains information related to each instance 134 of the ECIS 124 at the entities of the healthcare enterprise, such as the entities 104-114 of the example hospital 102, and stores the information in the ECIS instance database 202 (block 402). The data obtained and/or retrieved by the example ECIS instance tracker 200 is conveyed to the example application data extractor 204 and stored in the example distribution directory 210 (block 404). The example dependency calculator 206 then calculates dependencies between the application and stores the calculated information in the example dependency database 208 (block 406). As a result, the example EBS system 132 is aware of the current configuration of the example ECIS system 124 and the applications thereof.

As described above, the example ECIS 124 of FIG. 1 enables the entities 104-114, 120 and 122 to customize applications executed in association with the ECIS 124. The example detector 212 is to detect additions of new applications and modifications to existing applications associated with the ECIS 124. When the detector 212 detects such an event (block 408), the example updater 218 references the example dependency database 208 to determine whether the new or modified application(s) is dependent or interdependent on any other applications (block 410). If the new or modified application is not dependent or interdependent on another application, control returns to block 408. Otherwise, the example conflict resolver 216 detects and resolves any potential conflicts that may be presented by an update made to the dependent or interdependent application (block 412). Also, when the entity associated with the dependent or interdependent application to be updated wishes or prefers to have multiple concurrent versions of the application at issue (block 414), the example concurrent version resolver addresses the request for multiple concurrent versions of the application (block 416). Addressing the request includes, for example, identifying potential hazards or adverse effects of having multiple concurrent versions and/or determining a likelihood that the applications or, more generally, the ECIS 124 would be adversely affected. Depending on such determinations, the example concurrent version resolver 220 can select to allow or prohibit the multiple concurrent versions of an application to exist in an instance of the ECIS 124.

The example verifier 224 verifies the new or modified application and the validator 226 validates the new or modified application (block 418). As described above, the verification of an application or application bundle involves determining whether a set of requirements, standards, policies, or protocols associated with design and engineering of the application has been satisfied. Similarly, validation of the an application or application bundle involves determining whether the needs, preferences, requests, etc. of an entity associated with the new or modified application have been met. Then, the example licensing module 222 checks the licensing database 213 to determine with the entity associated with the dependent or interdependent application has any necessary licenses (block 420). As described above, a lack of the necessary license(s) can result in prohibition of the installation or updating of an application. The dependent or interdependent application is then updated by the updater 218 to include the most recent version of the ECIS 124 (block 422).

FIG. 5 is a block diagram of an example processor system 510 that may be used to implement the apparatus and methods described herein. As shown in FIG. 5, the processor system 510 includes a processor 512 that is coupled to an interconnection bus 514. The processor 512 may be any suitable processor, processing unit or microprocessor. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (I/O) controller 522. As is well known, a chipset typically provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (ATM) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

Thus, the example methods, apparatus, systems, and/or articles of manufacture disclosed herein enable an exchange of linkage information between healthcare entities such that healthcare practitioners associated with entities are quickly, efficiently, and accurately made aware of clinical items associated with medical issues of transferred patients. In addition to other benefits and advantages, the example methods, apparatus, systems, and/or articles of manufacture disclosed herein reduce or, in some instances, eliminate the need for the practitioners to reconcile clinical items with medical issues. As a result, the practitioners can provide more accurate and safe care in a more efficient manner. Additionally, the practitioners can focus a transfer process and the exchange of information associated therewith on the clinical items related to the medical issue(s) for which the patient is being transferred.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. An apparatus, comprising:
an instance tracker to obtain information related to a first instance of a clinical information system associated with a first healthcare entity of the clinical information system, wherein a plurality of instances of the clinical information system are installed in association with a plurality of healthcare entities of the clinical information system;
an extractor to extract information related to a first application of the first instance of the clinical information system associated with the first entity and to extract information related to a second application of a second instance of the clinical information system associated with a second entity of the clinical information system;
a dependency calculator to calculate dependency data of the first and second applications, wherein the dependency data indicates whether the first application is dependent on the second application; and
an updater to, when the dependency data indicates that the second application is dependent on the first application, update the second application in response to an update to the first application.

2. An apparatus as defined in claim 1, further comprising a licensing module to determine whether the second entity has a license required to install the update to the first application before updating the second application.

3. An apparatus as defined in claim 1, further comprising a detector to detect additions of or modifications to applications of the clinical information system.

4. An apparatus as defined in claim 1, further comprising a verifier to verify compliance of the update to the first application with a set of design standards.

5. An apparatus as defined in claim 1, further comprising a validator to validate compliance of the update to the first application with a set of quality control standards.

6. An apparatus as defined in claim 1, further comprising a directory to store the dependency data and identifying information of the first and second instances of the clinical information system.

7. An apparatus as defined in claim 1, wherein the first and second instances are different and updating the second application comprises installing the first instance of the clinical information system at the second entity.

8. A computer implemented method, comprising:
obtaining information related to a first instance of a clinical information system associated with a first healthcare entity of the clinical information system, wherein a plurality of instances of the clinical information system are installed in association with a plurality of healthcare entities of the clinical information system;
extracting information related to a first application of the first instance of the clinical information system associated with the first entity and to extract information related to a second application of a second instance of the clinical information system associated with a second entity of the clinical information system;
calculating dependency data of the first and second applications, wherein the dependency data indicates whether the first application is dependent on the second application; and
when the dependency data indicates that the second application is dependent on the first application, updating the second application in response to an update to the first application.

9. A computer implemented method as defined in claim 8, further comprising determining whether the second entity has a license required to install the update to the first application before updating the second application.

10. A computer implemented method as defined in claim 8, further comprising detecting additions of or modifications to applications of the clinical information system.

11. A computer implemented method as defined in claim 8, further comprising verifying compliance of the update to the first application with a set of design standards.

12. A computer implemented method as defined in claim 8, further comprising validating compliance of the update to the first application with a set of quality control standards.

13. A computer implemented method as defined in claim 8, further comprising storing the dependency data and identifying information of the first and second instances of the clinical information system in a directory.

14. A computer implemented method as defined in claim 8, wherein the first and second instances are different and updating the second application comprises installing the first instance of the clinical information system at the second entity.

15. A tangible computer readable medium having instructions stored thereon that, when executed, cause a machine to at least:
obtain information related to a first instance of a clinical information system associated with a first healthcare entity of the clinical information system, wherein a plurality of instances of the clinical information system are installed in association with a plurality of healthcare entities of the clinical information system;
extract information related to a first application of the first instance of the clinical information system associated with the first entity and to extract information related to a second application of a second instance of the clinical information system associated with a second entity of the clinical information system;
calculate dependency data of the first and second applications, wherein the dependency data indicates whether the first application is dependent on the second application; and
when the dependency data indicates that the second application is dependent on the first application, update the second application in response to an update to the first application.

16. A tangible computer readable medium as defined in claim 15, wherein the instructions, when executed, cause a machine to determine whether the second entity has a license required to install the update to the first application before updating the second application.

17. A tangible computer readable medium as defined in claim 15, wherein the instructions, when executed, cause a machine to detect additions of or modifications to applications of the clinical information system.

18. A tangible computer readable medium as defined in claim 15, wherein the instructions, when executed, cause a machine to verify compliance of the update to the first application with a set of design standards.

19. A tangible computer readable medium as defined in claim 15, wherein the instructions, when executed, cause a machine to validate compliance of the update to the first application with a set of quality control standards.

20. A tangible computer readable medium as defined in claim 15, wherein the instructions, when executed, cause a machine to store the dependency data and identifying information of the first and second instances of the clinical information system in a directory.

21. A tangible computer readable medium as defined in claim 15, wherein the first and second instances are different and updating the second application comprises installing the first instance of the clinical information system at the second entity.
